(19) United States
(12) Patent Application Publication
(10) Pub. No.: US 2018/0329498 A1
(43) Pub. Date: Nov. 15, 2018

(54) INPUT DEVICE

(71) Applicant: ALPS ELECTRIC CO., LTD., Tokyo (JP)

(72) Inventors: Hiroaki Takahashi, Miyagi-ken (JP); Daisuke Takai, Tokyo (JP); Hiroshi Shigetaka, Tokyo (JP); Kazuhito Oshita, Tokyo (JP); Jo Ri, Tokyo (JP)

(21) Appl. No.: 15/971,202

(22) Filed: May 4, 2018

(30) Foreign Application Priority Data
May 12, 2017 (JP) 2017-096054

(51) Int. Cl. G06F 3/01; G06F 3/041; G06F 3/047

(52) U.S. Cl. CPC G06F 3/016; G06F 3/047; G06F 3/0414

(57) ABSTRACT

Included are an operating surface, a touch sensor configured to detect touch operations of an operating member as to the operating surface, a pressure sensor configured to detect a pressing operation on the operating surface by the operating member, a tactile feedback presenting element configured to present tactile feedback, and a tactile feedback controller configured to control tactile feedback that the tactile feedback presenting element presents. When the touch sensor detects that a position indicated on a display screen by an operation as to the operating surface is an object on the display screen or a specified region of the display screen, and further the pressure sensor detects that a predetermined pressing operation has been performed as to an object region, the tactile feedback controller causes the tactile feedback presenting element to present tactile feedback corresponding to a double-clicking operation.

### CLAIM OF PRIORITY

This application claims benefit of priority to Japanese Patent Application No. 2017-096054 filed on May 12, 2017, which is hereby incorporated by reference in its entirety.

### BACKGROUND

### 1. Field of the Disclosure

The present disclosure relates to an input device capable of presenting tactile feedback in accordance with operations on an operating surface.

### 2. Description of the Related Art

In conventional input devices having touch sensors, command signals corresponding to clicking operations of a computer mouse are output in accordance with operations of tapping an operating screen with a finger, and command signals corresponding to double-clicking operations are output by consecutively performing tapping operations in a short time. In the following description tapping operations by finger will also be referred to as clicking operations.

However some users find it difficult to consecutively perform multiple clicking operations within a short time. There is a concern with the above-described conventional input device that whether or not double-clicking operations are successful will vary due to the intervals between consecutively-performed clicking operations. Further, whether or not double-clicking operations have been successful is confirmed by whether or not the display contents have changed, so there is a problem that performing confirmation of whether or not successful leads to lower work efficiency.

Now, an input device described in Japanese Unexamined Patent Application Publication No. 2011-48408 is purported to suppress variance in whether or not double-clicking operations are successful by, in a case where a pressing load satisfies a standard for presenting tactile sense, presenting a clicking tactile sense to the object that is pressing the touch face.

However, input device described in Japanese Unexamined Patent Application Publication No. 2011-48408 still requires whether or not double-clicking operations have been successful to be confirmed by whether or not the display contents have changed, so there is the problem that performing confirmation of whether or not successful leads to lower work efficiency.

### SUMMARY

An input device according to a first aspect includes an operating surface, a touch sensor configured to detect touch operations of an operating member as to the operating surface, a pressure sensor configured to detect a pressing operation on the operating surface by the operating member, a tactile feedback presenting element configured to present tactile feedback, and a tactile feedback controller configured to control tactile feedback that the tactile feedback presenting element presents. When the touch sensor detects that a position indicated on a display screen by an operation as to the operating surface is an object on the display screen or a specified region of the display screen, and further the pressure sensor detects that a predetermined pressing operation has been performed as to an object region, the tactile feedback controller causes the tactile feedback presenting element to present tactile feedback corresponding to a double-clicking operation. The predetermined pressing operation preferably is determined by at least one of pressure of the pressing operation, and duration of the pressing operation.

According to the input device of the first aspect, when performing a predetermined pressing operation as an operation corresponding to a double-clicking operation, the user can immediately sense whether or not the operation was successful, thereby enabling deterioration of work efficiency to be suppressed.

An input device according to a second aspect of the present invention includes an operating surface, a touch sensor configured to detect touch operations of an operating member as to the operating surface, a pressure sensor configured to detect a pressing operation on the operating surface by the operating member, a tactile feedback presenting element configured to present tactile feedback, and a tactile feedback controller configured to control tactile feedback that the tactile feedback presenting element presents. When the touch sensor detects that a position indicated on a display screen by an operation as to the operating surface is an object on the display screen or a specified region of the display screen, and further the touch sensor detects that a second operating member separate from the operating member has been placed in a specified region on the operating surface, the tactile feedback controller causes the tactile feedback presenting element to present tactile feedback corresponding to a double-clicking operation. The specified region preferably is a region separate from an object region, and the operating member and the second operating member are separate fingers.

According to the input device of the second aspect, when an operating member is placed in an object region on the operating surface and a second operating member that is separate from the operating member is paced in in a specified region on the operating surface, as an operation corresponding to a double-clicking operation, the user can immediately sense whether or not the operation was successful, thereby enabling deterioration of work efficiency to be suppressed.

### BRIEF DESCRIPTION OF THE DRAWINGS

FIGS. 1A and 1B illustrate an input device according to an embodiment of the present invention, where FIG. 1A is a side view illustrating the configuration of the input device, and FIG. 1B is a plan view thereof;

FIG. 2 is a functional block diagram of the input device according to the embodiment of the present invention;

FIG. 3 is a diagram illustrating the internal structure of a vibrating element according to the embodiment of the present invention;

FIG. 4 is a plan view of an electrostatic sensor according to the embodiment of the present invention;

FIG. 5 is a partially enlarged diagram of portion V in FIG. 4, illustrating the electrode structure of the electrostatic sensor illustrated in FIG. 4;

FIG. 6 is a cross-sectional view taken along line VI-VI in FIG. 5, illustrating the layered structure of the electrostatic sensor;

FIG. 7 is an enlarged frontal view where electrode patterns of the piezoelectric sensor according to the embodiment of the present invention are illustrated enlarged;

FIG. 8 is a cross-sectional view taken along line VIII-VIII in FIG. 7, illustrating the layered structure of a piezoelectric sensor;

FIG. 9 is an enlarged plan view illustrating a state where the piezoelectric sensor is laid on the electrostatic sensor;

FIG. 10 is a circuit block diagram illustrating wiring of the piezoelectric sensor, and a drive detection circuit, according to the embodiment of the present invention;

FIGS. 11A and 11B are diagrams for describing operations of the piezoelectric sensor in the embodiment of the present invention;

FIG. 12 is a flowchart illustrating the flow of processing when a clocking operation has been performed at the input device according to the embodiment of the present invention; and

FIGS. 13A and 13B illustrate an input device according to a modification of the present invention, where FIG. 13A is a side view of the input device, and FIG. 13B is a plan view thereof.

### DESCRIPTION OF THE EXEMPLARY EMBODIMENTS

An input device according to an embodiment of the present invention will be described below in detail, with reference to the drawings. This input device is used in a keyboard device for a personal computer, a touch panel used in a smartphone or tablet, and instrument panel of an automobile, and so forth. The entire input device can be configured of transparent materials, and thus be disposed overlaid upon a display such as a color liquid crystal panel or the like (on the front side of the display). A display device may be provided separately, without being overlaid by the input device. The drawings show X-Y-Z axes as reference axes. The Z axis is in the direction in which a glass plate serving as an operating surface, a piezoelectric sensor serving as a pressure sensor, and an electrostatic sensor serving as a touch sensor, are layered. The X-Y axis is a plane orthogonal to the Z axis. In the following description, the direction of the Z axis will be referred to as “vertical direction”, and a viewing along the Z axis from the upper side will be referred to as “plan view”.

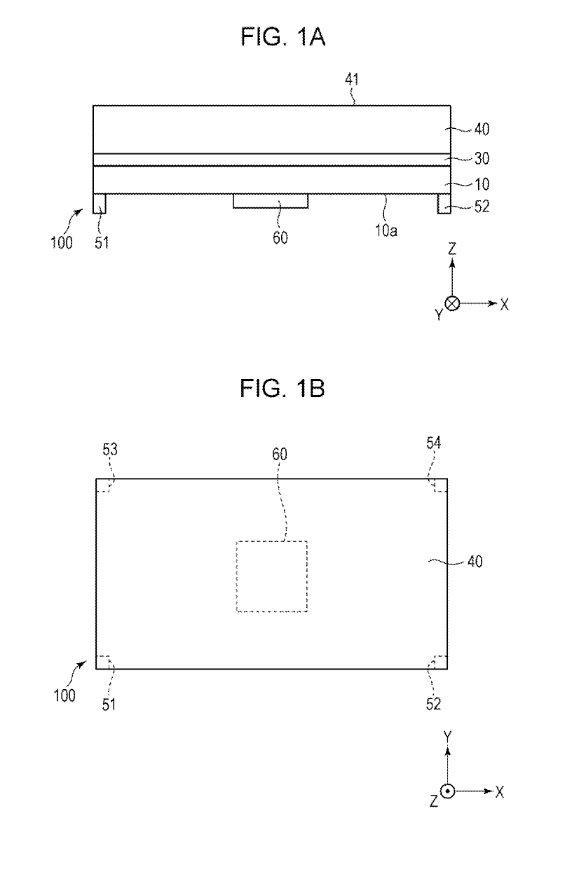

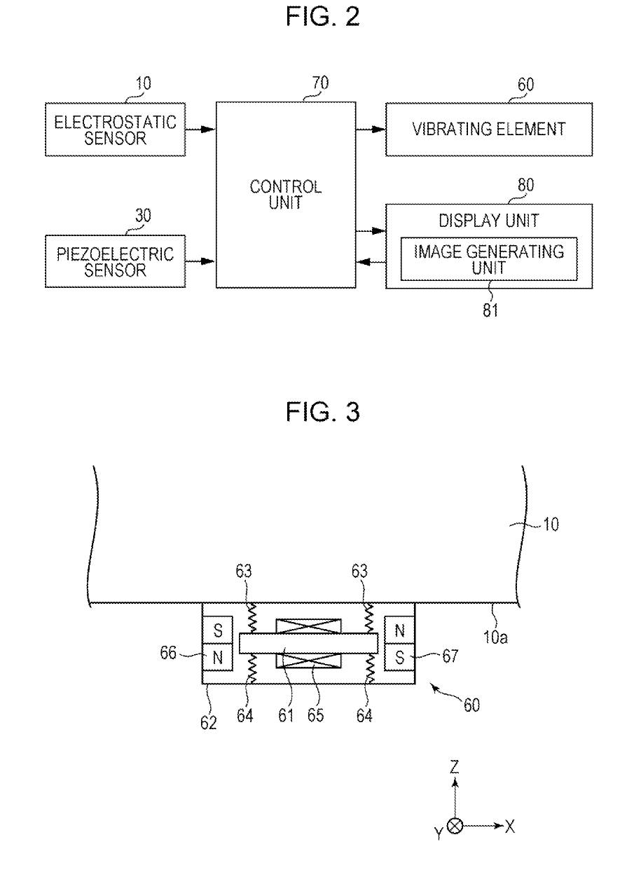

FIG. 1A is a side view illustrating the configuration of an input device 100 according to the present embodiment, and FIG. 1B is a plan view of the input device 100. FIG. 2 is a functional block diagram of the input device 100. FIG. 3 is a diagram illustrating the inner structure of a vibrating element 60. The input device 100 has a piezoelectric sensor 30 disposed upon an electrostatic sensor 10, and a glass plate 40 is further disposed upon the piezoelectric sensor 30. The electrostatic sensor 10, piezoelectric sensor 30, and glass plate 40 all have a same rectangular planar form that is long in the X direction, and are disposed so as to match in plan view.

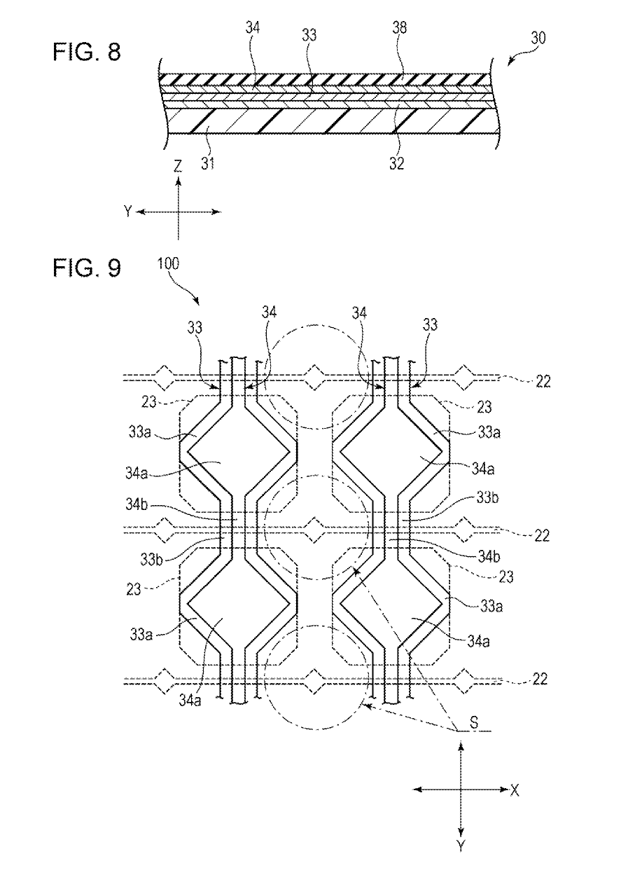

Although the piezoelectric sensor 30 is used as a pressure sensor in the present embodiment, a piezoelectric sensor having a configuration other than that illustrated in FIGS. 7 and 8 may be used, and electric resistance or electrostatic sensors may be used as long as pressure can be detected.

Suspension members 51, 52, 53, and 54 are attached to the four corners of a bottom face 10a of the electrostatic sensor 10, as illustrated in FIGS. 1A and 1B. The suspension members 51 through 54 are formed from a compression-deformable elastic material such as rubber or the like, a synthetic resin hinge that is elastically deformable, a compression coil spring, or the like. The suspension members 51 through 54 provided at the four locations all have the same shape, and have the same modulus of elasticity (spring constant). Note that suspension members 51 through 54 having different shapes or materials may be used, as long as the elasticity is the same.

The piezoelectric sensor 30 is fixed to the electrostatic sensor 10 by an adhesive agent (omitted from illustration). Performing a downward (in the down direction in FIG. 1A) pressing operation as to the glass plate 40 applies pressing force to the piezoelectric sensor 30, which is deformed by compression. The modulus of elasticity (spring constant) at the time of the piezoelectric sensor 30 deforming is appropriately set with regard to the modulus of elasticity (spring constant) when the suspension members 51 through 54 are contraction-deformed in the Z direction, so that desired output is obtained from the piezoelectric sensor 30.

A vibrating element 60 serving as a tactile feedback presenting element is provided at the middle of the bottom face 10a of the electrostatic sensor 10. The vibrating element 60 has a configuration where a vibrator 61 is supported by springs 63 and 64 within a metal case (cover) 62 so as to be capable of vibrating, as illustrated in FIG. 3. A coil 65 is wound around the vibrator 61, and magnets 66 and 67 are fixed within the case facing the coil. The magnet 66 and magnet 67 have magnetized faces facing the edge of the vibrator 61, with the magnetized faces having been magnetized so as to have different magnetic poles in the vibration direction of the vibrator 61. The faces of the magnet 66 and magnet 67 that face each other are of the opposite polarity to each other. AC current serving as a control signal is applied from a controller 70 (FIG. 2) serving as a tactile feedback controller to the coil 65, thereby vibrating the vibrator 61, and the vibrating element 60 presents later-described predetermined vibration information. That is to say, the vibrating element 60 presents predetermined vibration information as tactile feedback, under control of the controller 70. Note that the vibrating element 60 may be an arrangement where the vibrator is formed of a magnet, and a coil facing the vibrator is fixed within the case. A configuration may also be made where the vibrating element 60 is formed of a piezoelectric element, and vibrates in accordance with control signals from the controller 70. Further, in the configuration illustrated in FIG. 3, the vibrator 61 vibrates in the vertical direction along the Z axis, but the configuration of the vibrating element 60 is not restricted to this example, and may be of a configuration where the vibrating element vibrates in the X-Y plane direction. The controller 70 may also include a touchpad control microprocessor or a PC-BIOS for the Windows operating system (OS).

The vibrating element 60 operates in accordance with vibration request signals provided by the controller 70, and presents vibrations with varying intensity of vibration, vibration time, cycles and so forth. The controller 70 detects operations performed as to the glass plate 40, based on output signals from the electrostatic sensor 10. Operations detected by the controller 70 include operations corresponding to clicking operations in a case of using a mouse with regard to a computer, and operations regarding change in the display state of a display object on the display 80, e.g., enlarging, reducing, and rotating.

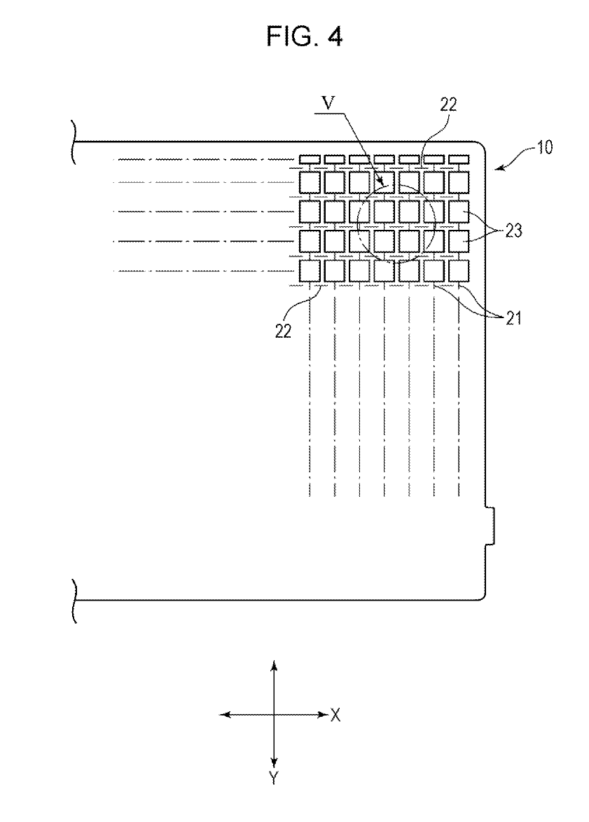

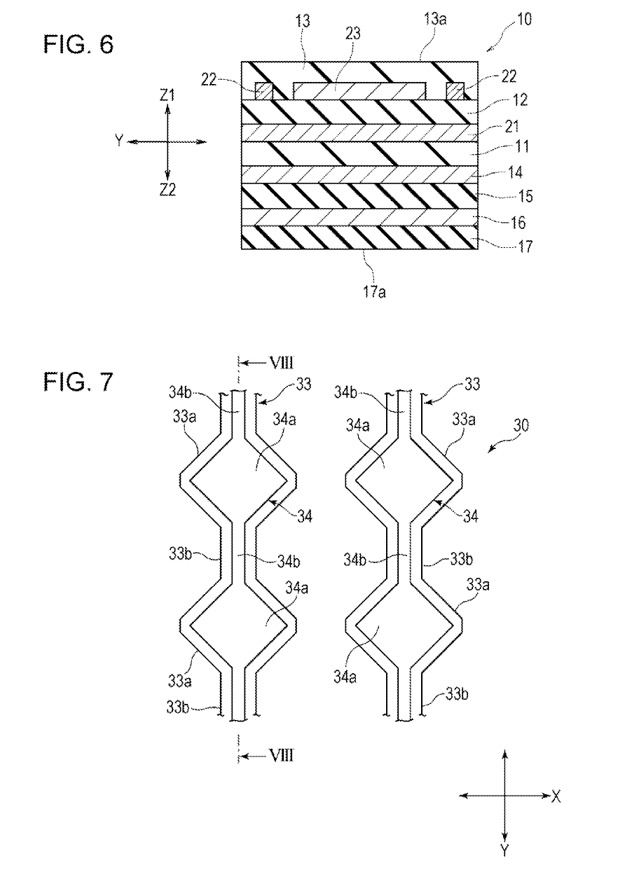

The structure of the electrostatic sensor 10 will be described with reference to FIGS. 4 through 6. The electrostatic sensor 10 is configured as a multi-layered rigid board such as illustrated in FIG. 6, having a predetermined rigidity. The electrostatic sensor 10 has an insulating base member 11 of polycarbonate or the like, with driving electrodes 21 that are electrostatic electrodes formed on the surface of the insulating base member 11 facing upwards (toward the upper side in the Z-axis direction). Above the driving electrodes 21 is covered by an inter-electrode insulating layer 12, and sensing electrodes 22 that are also electrostatic electrodes are formed on the surface of the inter-electrode insulating layer 12 facing upwards. An electroconductive layer 23 is formed on the surface of the inter-electrode insulating layer 12 facing upwards, between adjacent sensing electrodes 22. The sensing electrodes 22 and electroconductive layer 23 are covered by an upper insulating layer 13.

A shield electrode layer 14 that is set to grounding potential is provided on the entire face of the lower surface of the insulating base member 11 (lower side in the Z-axial direction), as illustrated in FIG. 6. A first lower insulating layer 15 is formed on the lower surface of the shield electrode layer 14, and a wiring layer 16 is formed on the lower surface of the first lower insulating layer 15. The wiring layer 16 is covered from below by a second lower insulating layer 17.

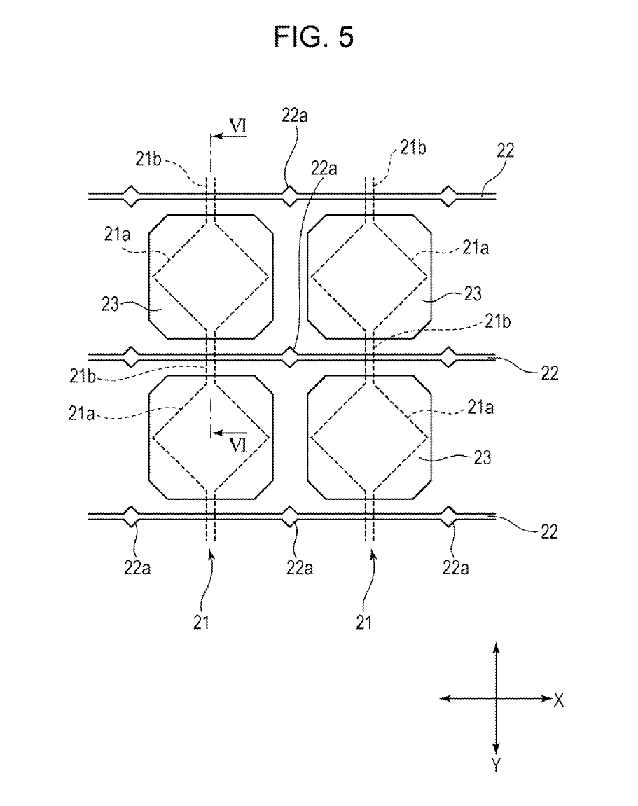

FIGS. 4 and 5 illustrate a planar pattern of the driving electrodes 21 and sensing electrodes 22 that are electrostatic electrodes, and the electroconductive layer 23. These electrostatic electrodes are formed by etching copper foil, or formed by a printing process using silver paste.

Each of the multiple driving electrodes 21 are formed extending in the Y direction, with predetermined spacing therebetween in the X direction. The driving electrodes 21 are formed with square (rhombic form) main electrode portions 21a and linking portions 21b continuing alternatingly, as an integrated form, as illustrated in FIG. 5. The main electrode portions 21a have a greater width dimension in the X direction than the linking portions 21b.

The sensing electrodes 22 are formed continuing in the X direction with predetermined spacing therebetween in the Y direction. Each of the sensing electrodes 22, and the linking portions 21b of the driving electrodes 21, intersect with the inter-electrode insulating layer 12 interposed therebetween. Sensing effect portions 22a that are slightly larger in the width dimension are provided between intersections between the sensing electrodes 22 and the driving electrodes 21.

The electroconductive layer 23 is formed on the same level as the sensing electrodes 22, on the surface of the inter-electrode insulating layer 12 facing upwards. The electroconductive layer 23 is connected neither to the sensing electrodes 22, nor to the driving electrodes 21 situated on the level below. Accordingly, the upward-facing surface of the electroconductive layer 23 is situated on the same imaginary plane parallel to the X-Y plane as the upward-facing surface of the sensing electrode 22.

The upward-facing surfaces of the sensing electrodes 22 and the electroconductive layer 23 situated therebetween is the same face, which makes it easier to smoothen an upward-facing surface 13a of the upper insulating layer 13 that covers the sensing electrodes 22 and electroconductive layer 23. Accordingly, the strength of adhesion when applying a sheet-like piezoelectric sensor 30 onto the smooth surface 13a can be made to be great. Accordingly, even if shearing force is generated in the piezoelectric sensor 30 by applying downward pressing force to the glass plate 40, the fixed state of the piezoelectric sensor 30 and electrostatic sensor 10 can be maintained. Also, the electroconductive layer 23 is formed into blocks, which are square, while the main electrode portions 21a of the driving electrodes 21 are rhombic, but the main electrode portions 21a and the blocks of the electroconductive layer 23 in the X direction and Y direction generally match in width. When driving power is applied to the driving electrodes 21, the main electrode portions 21a of the driving electrodes 21 are coupled with the electroconductive layer 23 situated thereabove through electrostatic capacitance.

The shield electrode layer 14 illustrated in FIG. 6 is formed such that the entire region of the downward-facing face (lower side in the Z-axial direction) of the insulating base member 11 is covered with copper foil, silver paste, or the like. The wiring layer 16 includes wiring conducting with the driving electrodes 21 and sensing electrodes 22, and is made up of multiple wiring lines. An integrated circuit (IC) or the like having a driving circuit built in is mounted to a downward-facing surface 17a of the second lower insulating layer 17, and the wiring lines are each connected to connection portions of the IC or the like.

Next, the structure of the piezoelectric sensor 30 will be described with reference to FIGS. 7 and 8. The piezoelectric sensor 30 is sheet-like as illustrated in FIG. 8, with a first electrode 32, piezoelectric layer 33, and second electrode 34 layer in order in the vertical direction, on the upward-facing surface of a film base member 31 formed of a synthetic resin material such as polyethylene terephthalate (PET). The first electrode 32 is a carbon electrode formed by screen printing. The piezoelectric layer 33 is formed thereupon by screen printing using piezoelectric paste, and further, the second electrode 34 is formed thereupon by screen printing. Moreover, the second electrode 34 is coated by an insulating coat 38.

Examples of piezoelectric paste include perovskite ferroelectric powder such as potassium niobate, sodium potassium, niobate barium titanate, or the like, being mixed in a thermoplastic polyester urethane resin to form a paste.

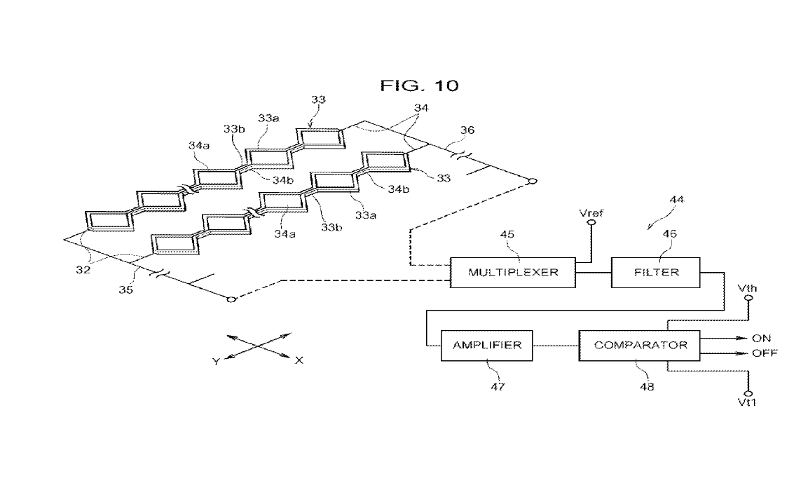

It can be seen from FIGS. 7 and 10 that multiple first electrodes 32 extend continuously in the Y direction, with intervals therebetween in the X direction. The piezoelectric layer 33 is formed with wide portions 33a and narrow portions 33b alternating in the Y direction. The second electrodes 34 are overlaid on the entire piezoelectric layer 33, and extend continuously in the Y direction along with the piezoelectric layer 33. Wide portions 34a and narrow portions 34b are also formed in the second electrodes 34, alternating in the Y direction. The first electrodes 32 and the second electrodes 34 have the same dimensions, and are overlaid so as to match in the vertical direction (Z direction).

A first electrode wiring layer 35 that connects to all first electrodes 32, and a second electrode wiring layer 36 that connects to all second electrodes 34, are provided on the inner side of an edge portion of the film base member 31 of the piezoelectric sensor 30 that extends in the X direction, as illustrated in FIG. 10. The first electrode wiring layer 35 and second electrode wiring layer 36 are led out from the piezoelectric sensor 30 and connected to the wiring layer 16 illustrated in FIG. 6, or connected to the CI or the like mounted to the lower-side surface of the electrostatic sensor 10. The first electrode wiring layer 35 and second electrode wiring layer 36 are connected to a driving detection circuit 44 built into the IC or the like.

The first electrode wiring layer 35 and second electrode wiring layer 36 are connected to a multiplexer 45 at the driving detection circuit 44, as illustrated in FIG. 10. One of the first electrode wiring layer 35 and second electrode wiring layer 36 is connected to reference voltage Vref by the multiplexer 45, and the other to a filter 46. The detection output from the multiplexer 45 passes through filter 46, is amplified at an amplifier 47, and applied to a comparator 48.

As illustrated in FIG. 1A, the input device 100 has the piezoelectric sensor 30 of the layered structure illustrated in FIG. 8 layered by adhesion on the upper face of the electrostatic sensor 10, i.e., on the upward-facing surface 13a of the upper insulating layer 13 illustrated in FIG. 6. The piezoelectric sensor 30 may be applied with the film base member 31 facing the surface 13a at this time, or with the insulating coat 38 covering the second electrodes 34 facing the surface 13a.

FIG. 9 illustrates a state of overlaying of the electrodes in the region where the piezoelectric sensor 30 is overlaid on the electrostatic sensor 10, as viewed from above. The first electrodes 32, piezoelectric layer 33, and second electrodes 34, of the piezoelectric sensor 30 are disposed laid above and following one of the driving electrodes 21 and sensing electrodes 22, out of the electrostatic electrodes of the electrostatic sensor 10. All of the first electrodes 32, the piezoelectric layer 33, and the second electrodes 34, are disposed overlaid along all driving electrodes 21 in the present embodiment.

Note that the first electrodes 32 and second electrodes 34 of the piezoelectric sensor 30 are of the same shape and same dimensions, and completely overlaid in the vertical direction. The first electrodes 32 and the wide portions 34a of the second electrode 34 are overlaid further above the main electrode portions 21a of the driving electrode 21 and the electroconductive layer 23 situated thereabove.

Next, the operations of the input device 100 will be described. First, the detection operations at the electrostatic sensor 10 and piezoelectric sensor 30 will be described.

The driving detection circuit 44 illustrated in FIG. 10 is constantly operating in the input device 100, with reference voltage Vref being applied to one of the first electrodes 32 and second electrodes 34, and the potential change of the other passing through the filter 46, being amplified at the amplifier 47, and applied to the comparator 48.

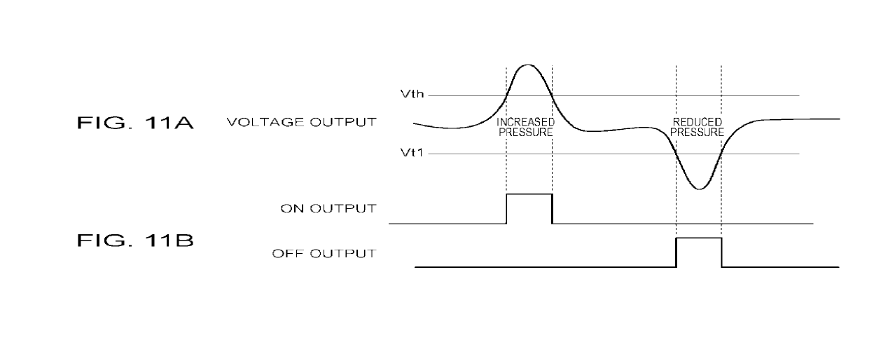

FIG. 11A illustrates change in voltage between the first electrodes 32 and second electrodes 34 when any position on the surface of the glass plate 40 is pressed by a finger or the like from above (increased pressure) and when the finger is away (reduced pressure), as voltage output. The voltage output illustrated in FIG. 11A changes in accordance with change in flexure acceleration of the piezoelectric sensor 30. The voltage change obtained by positive acceleration is subjected to waveform shaping and given as ON output at the comparator 48, while voltage change obtained by negative acceleration is subjected to waveform shaping and given as OFF output, as illustrated in FIG. 11B.

When ON output illustrated in FIG. 11B is obtained, the controller 70 detects that the input device 100 has been pressed by a finger or the like, and when OFF output is obtained, that the finger or the like has left the input device 100.

As illustrated in FIG. 9, the first electrodes 32 and the wide portions 34a of the second electrode 34, of the piezoelectric sensor 30, are formed having a relatively wide area on the surface of the electroconductive layer 23, so the area ratio of the first electrode 32 and second electrode 34 of 20% or more as to the entire area of the operating face can be secured, and preferably 30% or more. Accordingly, the detection sensitivity of the piezoelectric sensor 30 can be raised.

The sides of the first electrodes 32 and wide portions 34a of the second electrodes 34 form rhombic shapes that are angled as to the X-Y direction, while the sides of the blocks of the electroconductive layer 23 form squares extending in the X-Y direction, as illustrated in FIG. 9. Accordingly, when viewed from above, the four corners of the blocks of the electroconductive layer 23 protrude from the first electrodes 32 and wide portions 34a of the second electrodes 34. The sensing electrodes 22 pass between adjacent electroconductive layer 23 blocks and extend in the X direction.

Regions on the electrostatic sensor 10 where the first electrodes 32 of the piezoelectric sensor 30 and wide portions 34a of the second electrodes 34 do not exist are primary electrostatic detection regions S, as illustrated in FIG. 9. These electrostatic detection regions S are regions surrounded by multiple wide portions 34a, with four portions at the periphery thereof being surrounded by the corner portions of the electroconductive layer 23 blocks that are exposed from the wide portions 34a, with sensing electrodes 22 passing through the middle portions thereof.

Driving voltage is applied to the multiple driving electrodes 21 in order in the electrostatic sensor 10, but the main electrode portions 21a of the driving electrodes 21 are coupled with the electroconductive layer 23 in a floating state via electrostatic capacitance, so an electric field is formed above the glass plate 40 of the input device 100, from the electroconductive layer 23 to the sensing electrodes 22, at the electrostatic detection regions S. Accordingly, the coordinate position where a finger has touched the surface of the glass plate 40 can be detected with relatively high sensitivity, by monitoring change in current values flowing through the sensing electrodes 22 in order.

Overlaying the first electrodes 32 and second electrodes 34 of the piezoelectric sensor 30 so as to following the driving electrodes 21 of the electrostatic sensor 10, and overlaying the first electrodes 32 and the wide portions 34a of the second electrodes 34 above the wide main electrode portions 21a of the driving electrode 21 and the electroconductive layer 23 enables the footprint of the first electrodes 32 and second electrodes 34 to be maximized, and the detection sensitivity of the piezoelectric sensor 30 can be increased, as illustrated in FIG. 9. Moreover, the main electrode portions 21a or the electroconductive layer 23 coupled therewith are made to extend out from the first electrodes 32 and second electrodes 34, thereby enabling regions where the first electrodes 32 and second electrodes 34 are not present to be set to electrostatic detection regions S where detection sensitivity is high.

Note that the touch sensor and pressure sensor are not restricted to the above configurations. For example, the pressure sensor is not restricted to a piezoelectric sensor, and other types of pressure sensors, such as electric resistance or electrostatic capacitance sensors may be used. The pressure sensor may be disposed on the lower side of the board of the touch sensor, or may be disposed at the four corners of the board of the touch sensor.

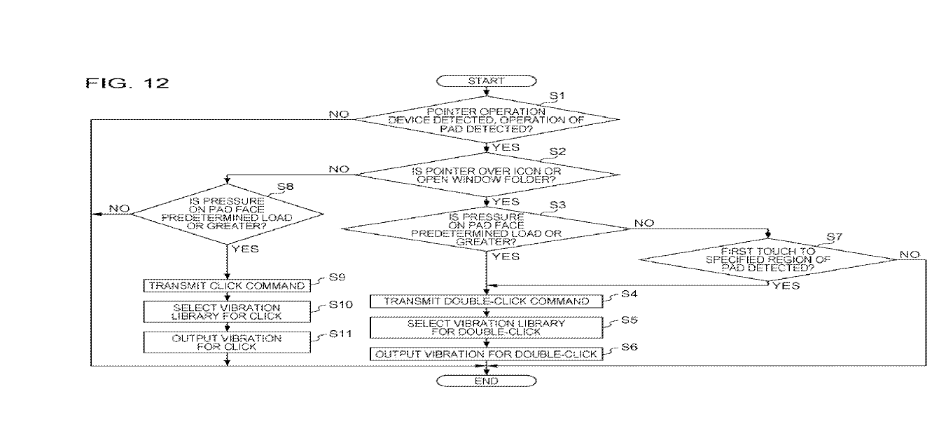

Next, processing when a clicking operation is performed at the input device 100 will be described with reference to FIG. 12. FIG. 12 is a flowchart illustrating the flow of processing when a clicking operation is performed at the input device 100. Although description will be made below regarding a configuration where a pointer moves on a separate display in accordance with a clicking operation by a finger on the input device 100, the same processing can be performed regarding a configuration where a display is mounter overlaid on the glass plate 40. Input devices such as a keyboard, mouse, and so forth are connected to the separate display, and moving of a cursor or pointer, editing of display objects, and so forth, are performed by operating these input devices. In a case where the display is a separate entity, the position indicated by the pointer on the display screen of the display is changed by operations made on the glass plate 40 serving as the operating surface. Conversely, in a case where the display is integrated, the position of the finger touching the display corresponds to the position indicated on the display screen.

First, the electrostatic sensor 10 detects whether or not the finger of the user, serving as a pointer operating device, has touched the pad face 41 (operating face) that is the surface of the glass plate 40 (step S1). If neither touch by a finger nor operation by a finger has been performed (NO in step S1), the flow ends.

In a case where a touch/operation by a finger has been performed in step S1 (YES in step S1), judgement is made regarding whether or not the position indicated on the display screen of the display in accordance with the operation by the finger, i.e., the position of the pointer, is above a display object such as an icon, window folder, or the like (step S2). This judgement is made by the controller 70, based on detection results made by the electrostatic sensor 10.

In a case where the pointer is above a display object in step S2 (YES in step S2), judgement is made regarding whether the load corresponding to the pressure by the finger as to the pad face 41 is a predetermined load is greater (step S3). This judgment is made by the controller 70, based on the detection results made by the piezoelectric sensor 30.

In a case where the pressure on the pad face 41 is a predetermined load or greater in step S3 (YES in step S3), the controller 70 transmits a command signal corresponding to a double-click operation to the display 80 side (step S4). Further, the controller 70 acts as a tactile feedback controller to select a vibration library saved in the storage unit beforehand, and applies drive signals corresponding thereto to the vibrating element 60 (step S5). The vibrating element 60 presents vibration information corresponding to a double-click operation in accordance with the drive signals (step S6).

In a case where the pressure on the pad face 41 is smaller than the predetermined load in step S3 (NO in step S3), detection is made regarding whether a first touch has been made to a specified region by a finger operation (step S7). The controller 70 performs this based on detection results made by the electrostatic sensor 10. Note that a specified region is a separate region from an object region, and is a region set only for distinguishing a double-click operation, set in a region where no display object is disposed, for example.

When a first touch has been detected in step S7 (YES in step S7), the controller 70 transmits command signals corresponding to a double-click operation to the display 80 side (step S4). Further, the controller 70 acts as a tactile feedback controller to select a vibration library saved in the storage unit beforehand, and applies drive signals corresponding thereto to the vibrating element 60 (step S5). The vibrating element 60 presents vibration information corresponding to a double-click operation in accordance with the drive signals (step S6).

On the other hand, in a case where a first touch is not detected in step S7 (NO in step S7), the flow ends.

In a case where the pointer is not over a display object in step S2 (NO in step S2), judgement is made regarding whether or not the load corresponding to the pressure by the finger on the pad face 41 is the predetermined load or greater (step S8). This judgement is made by the controller 70 based on the detection results made by the piezoelectric sensor 30.

In a case where the pressure on the pad face 41 is a predetermined load or greater in step S8 (YES in step S8), the controller 70 transmits a command signal corresponding to a click operation to the display 80 side (step S9), and acts as a tactile feedback controller to select a vibration library saved in the storage unit beforehand and apply drive signals corresponding thereto to the vibrating element 60 (step S10), in the same way as steps S4 through S6 described above. The vibrating element 60 presents vibration information corresponding to a click operation, in accordance with the drive signals (step S11).

In a case where the pressure on the pad face 41 is smaller than the predetermined load in step S8 (NO in step S8), the flow ends.

Due to this configuration, according to the above-described embodiment, when one of a double-click operation (step S6) and an operation corresponding to a double-click operation (steps S7 and S8) is performed, the user can immediately sense whether that operation has been successful or not by vibration information presented by the vibrating element 60, and accordingly deterioration of work efficiency can be suppressed.

A modification will be described below.

Although description has been made in the above embodiment that vibration information is presented corresponding to a double-click operation (step S10) in the three cases of

(A) a case of touch-and-release being been detected twice in a short time (step S6),

(B) a case of pressure being applied to the pad face 41 (step S7), and

(C) a case of a second finger coming into contact with a specified region (step S11),
as illustrated in FIG. 12, the present invention is not restricted to this. For example, vibration information may be presented regarding only one in the case of the above (B) and (C). Also, an arrangement may be made where vibration information is not presented in the case of the above (A).

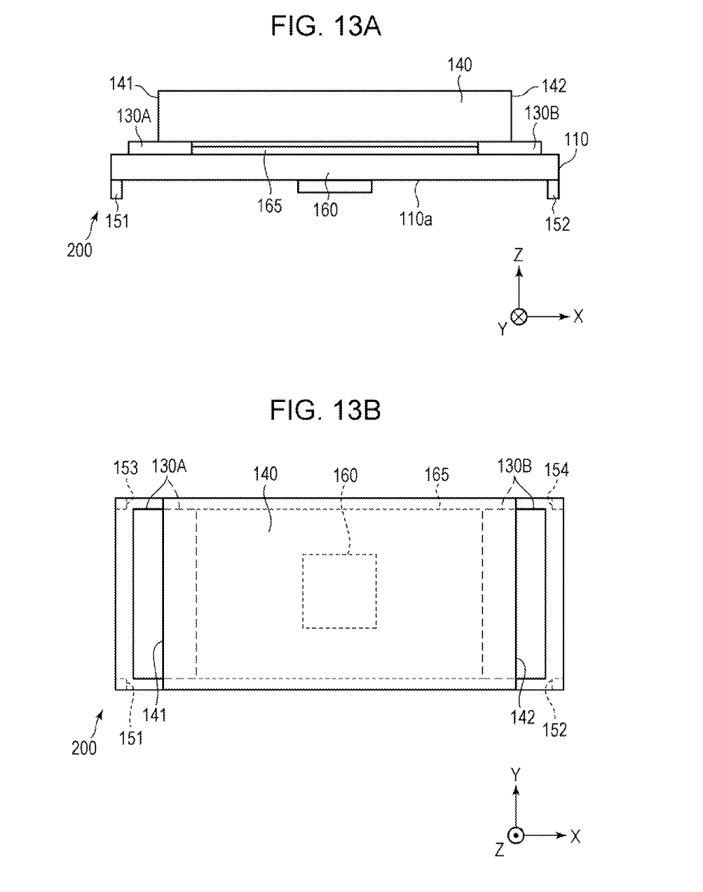

FIG. 13A is a side view of an input device 200 according to a modification of the above-described embodiment, and FIG. 13B is a plan view of the input device 200. In the input device 200 illustrated in FIGS. 13A and 13B, two voltage sensors 130A and 130B, and a spacer 165, are disposed on an electrostatic sensor 110. The spacer 165 is disposed between the two voltage sensors 130A and 130B in plan view. Further, one voltage sensor 130A is disposed straddling one edge 141 of a glass plate 140 in the X direction, and the other voltage sensor 130B is disposed straddling another edge 142 of the glass plate 140.

Four suspension members 151, 152, 153, and 154 are attached to the four corners of a bottom face 110a of the electrostatic sensor 110, in the same way as in the input device 100 illustrated in FIG. 1, and a vibrating element 160 is provided at the middle of the bottom face 110a. The electrostatic sensor 110, glass plate 140, suspension members 151, 152, 153, and 154, and the vibrating element 160, are the same as the electrostatic sensor 10, glass plate 40, suspension members 51, 52, 53, and 54, and vibrating element 60 in the above-described embodiment. The voltage sensors 130A and 130B differ from the piezoelectric sensor 30 in the embodiment described above with regard to planar shape, but are configured the same other than planar shape.

The spacer 165 is formed of a non-electroconductive synthetic resin, for example, and is formed thinner than the voltage sensors 130A and 130B. Accordingly, in a state where no external force is being applied to the glass plate 140, a gap is maintained between the spacer 165 and the glass plate 140, while in a case where external force of a predetermined magnitude is applied to the glass plate 140, the spacer 165 and the bottom face of the glass plate 140 come into contact.

When pressing force is applied to the input device 200, as external force from the upper side in the Z-axial direction, a range of the voltage sensors 130A and 130B corresponding to the glass plate 140 is pressured. Now, the amount of deformation of the voltage sensors 130A and 130B supported by adhesive agent is greater than the amount of contraction of the suspension members 151 through 154 due to difference in elasticity, so shearing force is applied in the direction of pressing (vertical direction) at the voltage sensors 130A and 130B, and the voltage sensors 130A and 130B contract downwards at a range corresponding to the glass plate 140. Thus, two voltage sensors 130A and 130B are used, and disposed to straddle the edge faces of the glass plate 140, so the pressing force on the glass plate 140 is concentrated as shearing force, and accordingly detection sensitivity can be improved.

Although the present invention has been described by way of the above-described embodiment, the present invention is not restricted to the above-described embodiment, and improvements or modifications may be made within the object of improvement and the scope of the spirit of the present invention.

As described above, the input device according to the present invention is useful in that when the user performs an operation corresponding to a double-clicking operation, whether or not that operation was successful can be immediately be sensed by presentation of tactile feedback, thereby enabling deterioration of work efficiency to be suppressed.

What is claimed is:

1. An input device comprising:
an operating surface;
a touch sensor configured to detect touch operations of an operating member as to the operating surface;
a pressure sensor configured to detect a pressing operation on the operating surface by the operating member;
a tactile feedback presenting element configured to present tactile feedback; and
a tactile feedback controller configured to control tactile feedback that the tactile feedback presenting element presents,
wherein, when the touch sensor detects that a position indicated on a display screen by an operation as to the operating surface is an object on the display screen or a specified region of the display screen, and further the pressure sensor detects that a predetermined pressing operation has been performed as to an object region, the tactile feedback controller causes the tactile feedback presenting element to present tactile feedback corresponding to a double-clicking operation.

2. The input device according to claim 1,
wherein the predetermined pressing operation is determined by at least one of pressure of the pressing operation, and duration of the pressing operation.

3. An input device comprising:
an operating surface;
a touch sensor configured to detect touch operations of an operating member as to the operating surface;
a pressure sensor configured to detect a pressing operation on the operating surface by the operating member;
a tactile feedback presenting element configured to present tactile feedback; and
a tactile feedback controller configured to control tactile feedback that the tactile feedback presenting element presents,
wherein, when the touch sensor detects that a position indicated on a display screen by an operation as to the operating surface is an object on the display screen or a specified region of the display screen, and further the touch sensor detects that a second operating member separate from the operating member has been placed in a specified region on the operating surface, the tactile feedback controller causes the tactile feedback presenting element to present tactile feedback corresponding to a double-clicking operation.

4. The input device according to claim 3,
wherein the specified region is a region separate from an object region, and the operating member and the second operating member are separate fingers.
